(19) United States
(12) Patent Application Publication
(10) Pub. No.: US 2010/0125413 A1
(43) Pub. Date: May 20, 2010

(54) EXTERNAL GYROSCOPE AND METHOD OF USING THE SAME TO ASSIST IN NAVIGATION AND POSITIONING

(76) Inventor: Benjamin WANG, Taipei County (TW)

Correspondence Address: Muncy, Geissler, Olds & Lowe, PLLC, P.O. BOX 1364, FAIRFAX, VA, 22038-1364, US

(21) Appl. No.: 12/272,357

(22) Filed: Nov. 17, 2008

(51) Int. Cl. G01C 21/00

(52) U.S. Cl. 701/213; 74/5 R; 701/220

(57) ABSTRACT

An external gyroscope is connectable to a navigator of any type to assist in navigation and positioning. The navigator has at least one first connector. The external gyroscope includes a mini-gyroscope adapted to generate angular displacement and acceleration data, a second connector for correspondingly connecting to the first connector, and a control unit. The control unit acquires the angular displacement and acceleration data and then directly transmits the same to the navigator. Alternatively, the control unit calculates the acquired angular displacement and acceleration data to generate a positioning signal for a next position, and then transmits the positioning signal to the navigator. A method of using the external gyroscope to assist a navigator in navigation and positioning is also provided.

### FIELD OF THE INVENTION

The present invention relates to an external gyroscope connectable to a navigator of any type to assist in navigation and positioning, and more particularly, to a method of using an external gyroscope to assist in navigation and positioning.

### BACKGROUND OF THE INVENTION

Nowadays, various satellite navigation systems have been widely used in different fields. For example. there are various in-car navigation systems and portable navigation devices. Also. many consumptive high-tech products, such as notebook computers, cellular phones, personal digital assistants (PDAs), etc., all can have navigation software installed thereon and be connected to a GPS receiver to provide navigation function. In this manner, the high-tech products can have increased added value.

Most of the existing navigators would sometimes display incorrect instructions due to certain factors, such as low accuracy or poor quality of satellite positioning signal. For example, when a car enters a tunnel, the navigator mounted on the car is not able to receive the satellite positioning signal and becomes useless. To overcome this problem, an advanced navigator would usually be equipped with a gyroscope to assist the navigator in continuously providing navigation and positioning function.

The gyroscope detects the movement of an object, such as braking, accelerating, or turning of a car, to thereby obtain some relevant data, such as instantaneous relative acceleration and instantaneous relative angular displacement due to inertia. Through calculation conducted on these data, it would help the navigator in correctly determining the moving speed and moving direction of the car. Taiwanese Patent Number I268201 entitled “Three-axis Mini-gyroscope” and Taiwanese Patent Number I284193 entitled “Car Navigator with Display Correcting Ability and Display Correcting Method Thereof” all disclose techniques related to navigation.

The currently available gyroscopes are small in size and adopt technique on chip. However, while there are many different types of navigators and navigation software, all the gyroscope-equipped navigators must be connected to the gyroscope in terms of hardware and software design thereof. Therefore, the gyroscope is usually provided only in the highly expensive advanced navigators. That is, most of the currently commercially available navigators do not support the gyroscopes and therefore are not advantageously assisted by the gyroscopes to provide improved navigation and positioning function.

It is therefore tried by the inventor to develop an external gyroscope, which can be plugged in any type of navigator without the problem of compatibility, just like a flash disk using a USB interface, so that all the existing navigators can use an external gyroscope to help in navigation and positioning. And, for this purpose, the navigator can have a driver installed thereon to enable compatibility of the external gyroscope with all types of navigators, so that the navigators can use an external gyroscope to help in the navigation and positioning without the need of modifying the navigation software thereof.

### SUMMARY OF THE INVENTION

A primary object of the present invention is to provide an external gyroscope connectable to a navigator of any type to assist the navigator in navigation and positioning, so that when a car equipped with the navigator enters a tunnel or the quality of GPS signal received by the navigator is poor, the external gyroscope connected to the navigator can help the navigator in providing accurate navigation and positioning.

Another object of the present invention is to provide a method of using an external gyroscope to assist in navigation and positioning. The method is applicable to a navigator that uses a GPS signal to determine a user's position. moving direction, and moving speed.

To achieve the above and other objects, the method of using an external gyroscope to assist in navigation and positioning according to an embodiment of the present invention includes the steps of: connecting an external gyroscope to a navigator. so that the navigator can acquire angular displacement and acceleration data generated by the external gyroscope; acquiring a GPS signal and calculating based on the GPS signal to obtain current moving direction and moving speed; combining the angular displacement and acceleration data with the current moving direction and moving speed, and conducting calculation on the combined data to generate a positioning signal for a next position; and replacing the GPS signal with the positioning signal for the next position and transmitting the positioning signal to the navigator.

There is also a method of using an external gyroscope to assist in navigation and positioning according to another embodiment of the present invention including the following steps: connecting an external gyroscope to a navigator; the navigator acquiring a GPS signal and calculating current moving direction and moving speed based on the GPS signal; and the navigator acquiring angular displacement and acceleration data generated by the external gyroscope, combining the angular displacement and acceleration data with the current moving direction and moving speed, and conducting calculation on the combined data to generate a positioning signal for the next position.

To achieve the above and other objects of the present invention, an external gyroscope connectable to a navigator according to the present invention includes a mini-gyroscope adapted to generate angular displacement and acceleration data, a second connector for correspondingly connecting to a first connector on the navigator; and a control unit electrically connected to and between the mini-gyroscope and the second connector. The control unit acquires the angular displacement and acceleration data and transmits the same to the navigator. Or, alternatively, the control unit can calculate based on the angular displacement and acceleration data to generate a positioning signal for a next position, and then transmits the positioning signal to the navigator.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 schematically shows a system architecture based on which the present invention is implemented:

FIG. 2 is a hardware block diagram of an external gyroscope according to the present invention;

FIG. 3 is a flowchart showing the steps included in a method of using an external gyroscope to assist in navigation and positioning according to a first embodiment of the present invention; and

FIG. 4 is a flowchart showing the steps included in a method of using an external gyroscope to assist in navigation and positioning according to a second embodiment of the present invention.

### DETAILED DESCRIPTION OF THE PREFERRED EMBODIMENTS

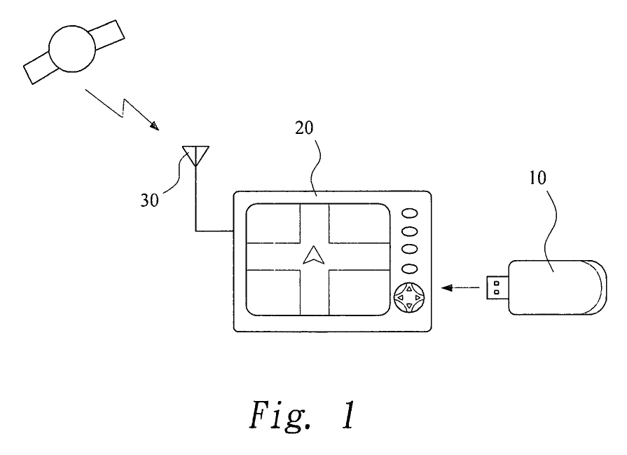

Please refer to FIG. 1 that schematically shows a system architecture based on which the present invention is implemented. The present invention provides an external gyroscope 10, which can be connected to and used with a currently available navigator 20 of any type. The navigator 20 is internally installed a type of navigation software for receiving a global positioning system (GPS) signal to enable correct navigation. The navigator 20 also includes a monitor, a control operator, and a voice speaker.

The currently commercially available navigators can be generally divided into two types. namely, navigators with a built-in GPS receiving chip and navigators requiring an external GPS receiver. For example, most existing car navigators and portable navigators have a built-in GPS receiving chip. On the other hand, notebook computers, hand computers, smart phones, and personal digital assistants (PDAs) that have internally installed navigation software would require an external GPS receiver to enable the navigation function thereof.

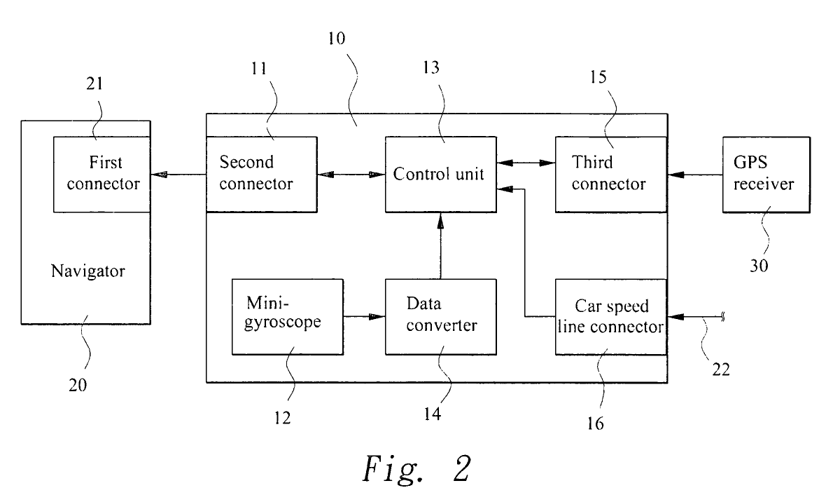

The following description of the external gyroscope of the present invention is based on a navigator 20 using an external GPS receiver 30. FIG. 2 is a hardware block diagram of the external gyroscope 10 according to the present invention. Please refer to FIGS. 1 and 2 at the same time. The navigator 20 is generally provided with one or more external connector ports, such as a memory card connector port, a GPS receiver connector port, an AV input port, a Bluetooth interface, etc. Herein, the navigator 20 is provided with at least one first connector 21 for connecting to the external gyroscope 10. The external gyroscope 10 is correspondingly provided with a second connector 11 for connecting to the first connector 21 on the navigator 20.

The external gyroscope 10 further includes a mini-gyroscope 12 and a control unit 13. The mini-gyroscope 12 is able to generate instantaneous angular displacement and acceleration data in the instant a vehicle moves. The mini-gyroscope 12 can be provided with a G-sensor or a pressure altimeter to help in correcting any height error in the GPS signal. The control unit 13 is mainly a controller of the transmission interface at the second connector 11. The control unit 13 is electrically connected to the mini-gyroscope 12 and the second connector 11 to acquire the angular displacement and acceleration data generated by the mini-gyroscope 12 and transmit the acquired data to the navigator 20 via the second connector 11.

A data converter 14 can be provided between the control unit 13 and the mini-gyroscope 12. The data converter 14 converts the angular displacement and acceleration data generated by the mini-gyroscope 12 into transmission data corresponding to the connection interface of the second connector 11. Preferably, the control unit 13 is able to directly convert the data, so that the data converter 14 can be omitted.

The external gyroscope 10 is further provided with at least one third connector 15 electrically connected to the control unit 13 for connecting to an external GPS receiver 30. Therefore, the navigator 20 without a built-in GPS receiving chip can have its external GPS receiver 30 connected to the third connector 15 on the external gyroscope 10.

The control unit 13 of the external gyroscope 10 is able to automatically detect that a GPS receiver 30 has been connected to the third connector 15, and acquires the GPS signal generated by the GPS receiver 30. The control unit 13 will then combine the angular displacement and acceleration data generated by the mini-gyroscope 12 with the GPS signal, and conduct calculation on the combined data to derive a positioning signal for a next position. The positioning signal is then transmitted to the navigator 20 for navigation and positioning.

According to the illustrated embodiment of FIG. 2, modification or change of the navigation software installed on the navigator 20 call be minimized. This is because the external gyroscope 10 will automatically combine the angular displacement and acceleration data with the GPS signal to derive the positioning signal for a next position. This helps in correcting the GPS signal generated by the GPS receiver 30 before the GPS signal is transmitted to the navigator 20. Therefore, the GPS signal acquired by the navigator 20 is always an accurate positioning signal, and it is not necessary for the navigation software in the navigator 20 to calculate the next position.

The first connector 21 on the navigator 20, the second connector 11 and/or the third connector 15 on the external gyroscope 10, and the GPS receiver 30 are of the same connection interface, which can be a universal serial bus (USB) interface, an RS-232 interface, a PS/2 interface, an IEEE 1394 interface. or any universal asynchronous receiver/transmitter (UART) interface. For example, the first connector 21 can be a USB female connector, while the second connector 11 can be a mating USB male connector. Alternatively, the first and the second connector 21. 11 can be two PS/2 female connectors connectable to each other via a PS/2 connection cable.

The first connector 21 and the second connector 11 or the third connector 15 and the GPS receiver 30 can be otherwise a memory card connection interface or a Personal Computer Memory Card Association (PCMCIA) interface. such as an SD card connector, a CF card connector, a PCMCIA connector, etc. Alternatively, the first connector 21 and the second connector 11 or the third 10 connector 15 and the GPS receiver 30 can be otherwise a Bluetooth interface for wireless connection via Bluetooth technique.

The external gyroscope 10 of the present invention can further include a car speed line connector 16 for connecting to a car speed line 22 to acquire car speed data, which can substitute for the acceleration data generated by the external gyroscope 10. Therefore, the burden on the control unit 13 for calculating the car moving speed during the derivation of the positioning signal can be lowered.

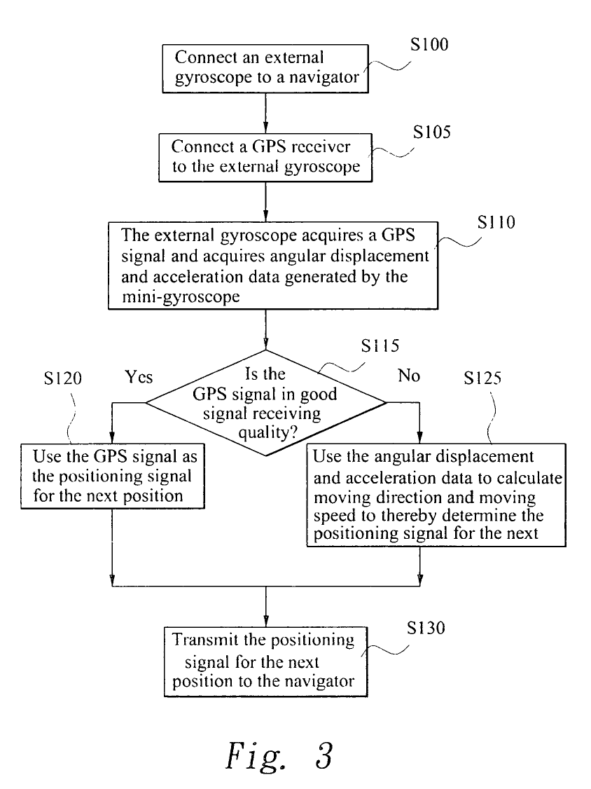

Please now refer to FIG. 3, which is a flowchart showing the steps included in a method of using an external gyroscope to assist in navigation and positioning according to a first embodiment of the present invention. As having been described above, the external gyroscope 10 is connected to a navigator 20, which is able to receive a GPS signal and determines the user's position, moving direction, and moving speed based on the GPS signals. The method of using the external gyroscope 10 to assist a navigator 20 in navigation and positioning according to the first embodiment of the present invention includes the following steps:

Step S100: Connect the external gyroscope 10 to the navigator 20, so that the navigator 20 can acquire the angular displacement and acceleration data generated by the external gyroscope 10. The external gyroscope 10 can be further provided with a G-sensor or a pressure altimeter to help in correcting any height error in the GPS signal.

Step S105: Connect the GPS receiver 30 to the external gyroscope 10, and turn on the navigator 20 to run the built-in navigation software thereof.

Step S110: When the navigation software runs and needs to acquire a GPS signal from the GPS receiver 30. the external gyroscope 10 acquires and combines the GPS signal generated by the GPS receiver 30 with the angular displacement and acceleration data generated by the mini-gyroscope 12, and conducts necessary calculation based on the combined GPS signal and angular displacement and acceleration data.

Step S115: The control unit 13 determines whether the GPS signal is in good signal receiving quality.

Step S120: If yes, the received GPS signal is used as the positioning signal for a next position.

Step S125: Or, if no, the angular displacement data generated by the external gyroscope 10 is used to calculate the current moving direction and angular position. Meanwhile, the acceleration data generated by the external gyroscope 10 is used to calculate the vehicle moving speed, so as to determine the positioning signal for a next position.

Step S130: Finally, the positioning signal for the next position is transmitted to the navigator 20 for the same to provide required navigation and positioning.

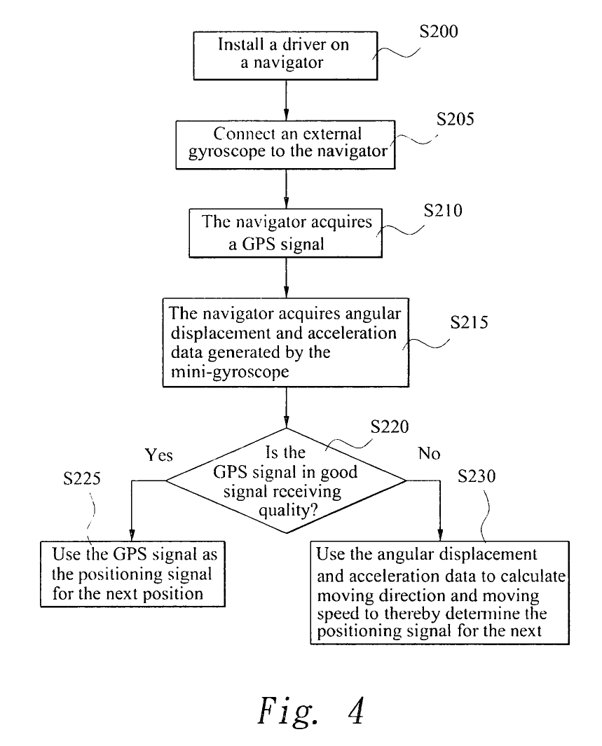

Alternatively, the external gyroscope 10 can be connected to a car speed line 22 to acquire data about the vehicle moving speed. In this case, the car moving speed data can substitute for the acceleration data generated by the mini-gyroscope 12, and be combined with the GPS signal for calculating the positioning signal for the next position. FIG. 4 is a flowchart showing the steps included in a method of using an external gyroscope to assist in navigation and positioning according to a second embodiment of the present invention. In the second embodiment, the external gyroscope 10 is connected to a navigator 20 having a built-in GPS receiving chip. The built-in GPS receiving chip is controlled by navigation software installed in the navigator. The method of using an external gyroscope to assist in navigation and positioning according to the second embodiment of the present invention includes the following steps:

Step S200: Install a resident driver in the navigator 20 for detecting any acquisition of a GPS signal by the navigator. The resident driver enables less modification or change to the navigation software and accordingly, increased system compatibility of the external gyroscope 10 with the navigator 20.

Step S205: Connect the external gyroscope 10 to the navigator 20 for the latter to acquire angular displacement and acceleration data generated by the mini-gyroscope 12 of the external gyroscope 10.

Step S210: The navigator 20 acquires a GPS signal and conducts calculation based on the GPS signal to obtain current moving direction and moving speed.

Step S215: The resident driver installed on the navigator 20 acquires the angular displacement and acceleration data generated by the external gyroscope 10. The external gyroscope 10 can be further provided with a G-sensor or a pressure altimeter to help in correcting any height error in the GPS signal. Then, the resident driver combines the current moving direction and moving speed with the angular displacement and acceleration data for calculating a positioning signal for a next position.

Step S220: The resident driver determines whether the GPS signal is in good signal receiving quality.

Step S225: If yes, the GPS signal is combined with the angular displacement and acceleration data and the moving direction and moving speed to calculate and generate the positioning signal for the next position.

Step S230: Or, if no, the angular displacement and acceleration data generated by the external gyroscope 10 is directly used to calculate and generate the positioning signal for the next position.

In the second embodiment, the navigator 20 can be connected to a car to speed line 22 to acquire car speed data. In this case, the car speed data can substitute for the acceleration data provided by the external gyroscope 10 to be combined with the GPS signal for calculating the positioning signal for the next position.

A biggest difference between the method in the first embodiment and the method in the second embodiment mainly is that, in the first embodiment, the positioning signal for the next position is calculated and then transmitted to the navigator by the external gyroscope, while in the second embodiment, the external gyroscope simply transmits data to the navigator for the navigator to calculate the positioning signal. Thus, the external gyroscope used in the method of the first embodiment enables the navigator to have higher compatibility, while the external gyroscope used in the method of the second embodiment has cost-effective design and provides best operating efficiency.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A method of using external gyroscope to assist in navigation and positioning, the method being applicable to a navigator, which is able to determine a user's position, moving direction, and moving speed based on a GPS signal, the method comprising the following steps:
a. connecting an external gyroscope to the navigator, so that the navigator acquires angular displacement and acceleration data generated by the external gyroscope;
b. acquiring a GPS signal for calculating current moving direction and moving speed;
c. combining the angular displacement and acceleration data with the current moving direction and moving speed to calculate and generate a positioning signal for a next position; and
d. replacing the GPS signal with the positioning signal for the next position, and transmitting the positioning signal to the navigator.

2. The method of using external gyroscope to assist in navigation and positioning as claimed in claim 1, wherein the step a further comprising the step of installing a driver on the navigator for acquiring the GPS signal and acquiring the angular displacement and acceleration data generated by the gyroscope.

3. The method of using external gyroscope to assist in navigation and positioning as claimed in claim 1, wherein, in the step a, the external gyroscope is connected to the navigator via a connection interface selected from the group consisting of a USB interface, an RS-232 interface, a PS/2 interface, an IEEE 1394 interface, and a UART interface.

4. The method of using external gyroscope to assist in navigation and positioning as claimed in claim 1, wherein, in the step a, the external gyroscope is connected to the navigator via a Bluetooth wireless transmission interface.

5. The method of using external gyroscope to assist in navigation and positioning as claimed in claim 1, wherein, in the step a, the external gyroscope is provided with a G-sensor or a pressure altimeter to help in correcting any height error in the GPS signal.

6. The method of using external gyroscope to assist in navigation and positioning as claimed in claim 1, wherein, in the step b, the GPS signal is received by a built-in GPS receiving chip of the navigator.

7. The method of using external gyroscope to assist in navigation and positioning as claimed in claim 1, wherein, in the step b, the GPS signal is received by a GPS receiver connected to the external gyroscope.

8. The method of using external gyroscope to assist in navigation and positioning as claimed in claim 7, wherein the GPS receiver is connected to the external gyroscope via a connection interface selected from the group consisting of a USB interface, an RS-232 interface, a PS/2 interface, an IEEE 1394 interface, and a UART interface.

9. The method of using external gyroscope to assist in navigation and positioning as claimed in claim 7, wherein the GPS receiver is connected to the external gyroscope via a Bluetooth wireless transmission interface.

10. The method of using external gyroscope to assist in navigation and positioning as claimed in claim 1, wherein, in the step b, the current moving speed is obtained by acquiring car speed data via a car speed line.

11. The method of using external gyroscope to assist in navigation and positioning as claimed in claim 10, wherein the car speed line is connected to the external gyroscope.

12. The method of using external gyroscope to assist in navigation and positioning as claimed in claim 1, wherein the step c further comprising the steps of determining whether the GPS signal is in good signal receiving quality; if yes, using the GPS signal to calculate the current moving direction and moving speed; or, if no, using the angular displacement and acceleration data generated by the external gyroscope to calculate the current moving direction and moving speed.

13. The method of using external gyroscope to assist in navigation and positioning as claimed in claim 12, wherein the current moving speed is obtained by acquiring car speed data via a car speed line.

14. The method of using external gyroscope to assist in navigation and positioning as claimed in claim 13, wherein the car speed line is connected to the external gyroscope.

15. A method of using external gyroscope to assist in navigation and positioning, the method being applicable to a navigator, which is able to determine a position, moving direction, and moving speed based on a GPS signal, the method comprising the following steps:
a. connecting an external gyroscope to the navigator;
b. the navigator acquiring a GPS signal for calculating current moving direction and moving speed; and
c. the navigator acquiring angular displacement and acceleration data generated by the external gyroscope, and combining the angular displacement and acceleration data with the current moving direction and moving speed for calculating a positioning signal for a next position.

16. The method of using external gyroscope to assist in navigation and positioning as claimed in claim 15, wherein the step b further comprising the step of installing a driver on the navigator for detecting any acquisition of the GPS signal by the navigator and acquiring the angular displacement and acceleration data generated by the external gyroscope.

17. The method of using external gyroscope to assist in navigation and positioning as claimed in claim 15, wherein, in the step a, the external gyroscope is provided with a G-sensor or a pressure altimeter to help in correcting any height error in the GPS signal.

18. The method of using external gyroscope to assist in navigation and positioning as claimed in claim 15, wherein, in the step a, the external gyroscope is connected to the navigator via a connection interface selected from a group consisting of a USB interface, an RS-232 interface, a PS/2 interface, an IEEE 1394 interface, and a UART interface.

19. The method of using external gyroscope to assist in navigation and positioning as claimed in claim 15, wherein, in the step a, the external gyroscope is connected to the navigator via a Bluetooth wireless transmission interface.

20. The method of using external gyroscope to assist in navigation and positioning as claimed in claim 15, wherein, in the step b, the GPS signal is received by a built-in GPS receiving chip of the navigator.

21. The method of using external gyroscope to assist in navigation and positioning as claimed in claim 15, wherein, in the step b, the current moving speed is obtained by acquiring car speed data via a car speed line.

22. The method of using external gyroscope to assist in navigation and positioning as claimed in claim 15, wherein the step c further comprising the steps of determining whether the GPS signal is in good signal receiving quality; if yes, combining the GPS signal with the angular displacement and acceleration data as well as the current moving direction and moving speed to calculate the positioning signal for the next position; or, if no, directly using the angular displacement and acceleration data generated by the external gyroscope to calculate the positioning signal for the next position.

23. An external gyroscope connectable to a navigator, the navigator being able to determine a position, a moving direction, and a moving speed based on a GPS signal, and having at least one first connector; the external gyroscope comprising:
a mini-gyroscope for generating angular displacement and acceleration data;
a second connector for correspondingly connecting to the first connector on the navigator; and
a control unit being electrically connected to the mini-gyroscope and the second connector, and being adapted to acquire and directly transmit the angular displacement and acceleration data to the navigator or alternatively, being adapted to acquire and calculate based on the angular displacement and acceleration data to generate a positioning signal for a next position and then transmit the positioning signal to the navigator.

24. The external gyroscope as claimed in claim 23, wherein the navigator is selected from the group consisting of a car navigator and a portable navigator.

25. The external gyroscope as claimed in claim 23, wherein the navigator is selected from the group consisting of a notebook computer, a hand computer, a smart phone, and a PDA with built-in navigation software.

26. The external gyroscope as claimed in claim 23, wherein the mini-gyroscope is provided with a G-sensor or a pressure altimeter to help in correcting any height error in the GPS signal.

27. The external gyroscope as claimed in claim 23, wherein the first connector and the second connector are of a connection interface selected from the group consisting of a USB interface, an RS-232 interface, a PS/2 interface, an IEEE 1394 interface, and a UART interface.

28. The external gyroscope as claimed in claim 27, wherein the first connector and the second connector are two mating female connector and male connector.

29. The external gyroscope as claimed in claim 27, wherein the first connector and the second connector are connected to each other via a connection cable.

30. The external gyroscope as claimed in claim 23, wherein the first connector and the second connector are of a connection interface selected from the group consisting of a memory card connection interface and a PCMCIA interface.

31. The external gyroscope as claimed in claim 23, wherein the first connector and the second connector are of a Bluetooth interface and are wirelessly connected to each other.

32. The external gyroscope as claimed in claim 23, further comprising a data converter electrically connected to and between the mini-gyroscope and the control unit for converting the angular displacement and acceleration data generated by the mini-gyroscope into transmission data corresponding to the connection interface of the first and the second connectors.

33. The external gyroscope as claimed in claim 23, further comprising a GPS receiver connector electrically connected to the control unit, the GPS receiver connector being connectable to an external GPS receiver for acquiring a GPS signal generated by the external GPS receiver.

34. The external gyroscope as claimed in claim 33, wherein the GPS receiver connector is of a connection interface selected from the group consisting of a USB interface, an RS-232 interface, a PS/2 interface, an IEEE 1394 interface, and a UART interface.

35. The external gyroscope as claimed in claim 33, wherein the GPS receiver connector is of a Bluetooth interface.

36. The external gyroscope as claimed in claim 23, further comprising a car speed line connector electrically connected to the control unit, the car speed line connector being connectable to a car speed line to acquire car moving speed data, and the car moving speed data being able to substitute for the acceleration data.
